(19) United States
(12) Patent Application Publication
(10) Pub. No.: US 2023/0051909 A1
(43) Pub. Date: Feb. 16, 2023

(54) DOOR PINCH DETECTION SYSTEM AND METHOD

(71) Applicant: Toyota Motor Engineering & Manufacturing North America, Inc., Plano, TX (US)

(72) Inventor: Matthew D. Ortiz, Belleville, MI (US)

(21) Appl. No.: 17/399,553

(22) Filed: Aug. 11, 2021

(51) Int. Cl. E05F 15/48

(52) U.S. Cl. CPC E05F 15/48; B62D 33/027

(57) ABSTRACT

A door pinch detection system includes a pinch detector, a mount for the pinch detector, and an actuator for the mount. The pinch detector is configured to detect contact with objects adjacent the pinch detector. The mount is mountable to a vehicle door including a peripheral flange, and the actuator is mountable to the vehicle door and connectable between the vehicle door and the mount. The mount is configured to support the pinch detector for movement between an inboard position and an outboard position, in which the pinch detector is respectively located along the inside and the outside of the peripheral flange and configured to detect contact between the inside and the outside of the peripheral flange and objects. The actuator is operable to activate the mount to move the pinch detector between the inboard position and the outboard position.

### TECHNICAL FIELD

The embodiments disclosed herein relate to vehicle doors and, more particularly, to pinch detection systems for vehicle doors.

### BACKGROUND

Some vehicle doors may include sensors for determining if the door will contact an object. For example, some vehicle doors include Hall sensors.

### SUMMARY

Disclosed herein are embodiments of a door pinch detection system.

In one aspect, the door pinch detection system includes a pinch detector, a mount for the pinch detector, and an actuator for the mount. The pinch detector is configured to detect contact with objects adjacent the pinch detector. The mount is mountable to a vehicle door including a peripheral flange, and the actuator is mountable to the vehicle door and connectable between the vehicle door and the mount. The mount is configured to support the pinch detector for movement between an inboard position and an outboard position, in which the pinch detector is respectively located along the inside and the outside of the peripheral flange and configured to detect contact between the inside and the outside of the peripheral flange and objects. The actuator is operable to activate the mount to move the pinch detector between the inboard position and the outboard position.

This and other aspects will be described in additional detail below.

### BRIEF DESCRIPTION (F THE DRAWINGS

The various features, advantages and other uses of the present embodiments will become more apparent by referring to the following detailed description and drawing in which:

FIGS. 1A and 1B are side views of a door of a vehicle, showing an example of an outer door panel and an example of an inner door cavity of the door.

FIG. 2 is an example of a door pinch detection system.

FIG. 3A is a cross-section of the door of FIGS. 1A and 1B taken along the line A-A showing a door pinch detection system of the door in an inboard position.

FIG. 3B a cross-section of the door of FIGS. 1A and 1B taken along the line A-A showing the door pinch detection system moving from the inboard position to an outboard position,

FIG. 3C is a cross-section of the door of FIGS. 1A and 1B taken along the line A-A showing the door pinch detection system in the outboard position.

FIG. 4 is an example of a method for using the door pinch detection system.

### DETAILED DESCRIPTION

This disclosure teaches a door pinch detection system. The door pinch detection system includes a pinch detector, a mount for the pinch detector, and an actuator for the mount. The pinch detector is configured to detect contact with objects adjacent the pinch detector. The mount is mountable to a vehicle door including a peripheral flange, and the actuator is mountable to the vehicle door and connectable between the vehicle door and the mount. The mount is configured to support the pinch detector for movement between an inboard position and an outboard position, in which the pinch detector is respectively located along the inside and the outside of the peripheral flange and configured to detect contact between the inside and the outside of the peripheral flange and objects. The actuator is operable to activate the mount to move the pinch detector between the inboard position and the outboard position. The door pinch detection system can be used to prevent injury to a person and/or to prevent damage to a vehicle door.

The vehicle can be any suitable vehicle. For example, the vehicle can be any passenger vehicle, including a sedan, an SUV, a minivan, a truck, a hatchback, etc. The vehicle includes an exterior 10 and a number of interior compartments. The compartments include a passenger compartment, an engine compartment, a cargo area, and the like. Among other things, the vehicle includes seats, a dash assembly, an instrument panel, controls, and the like housed in the passenger compartment Additionally, the vehicle includes an engine, a motor, a transmission, and the like, as well as other powertrain components, such as wheels, housed in the engine compartment and elsewhere in the vehicle. The wheels support the remainder of the vehicle on the ground, One, some, or all of the wheels are powered by the remainder of the powertrain components to drive the vehicle along the ground.

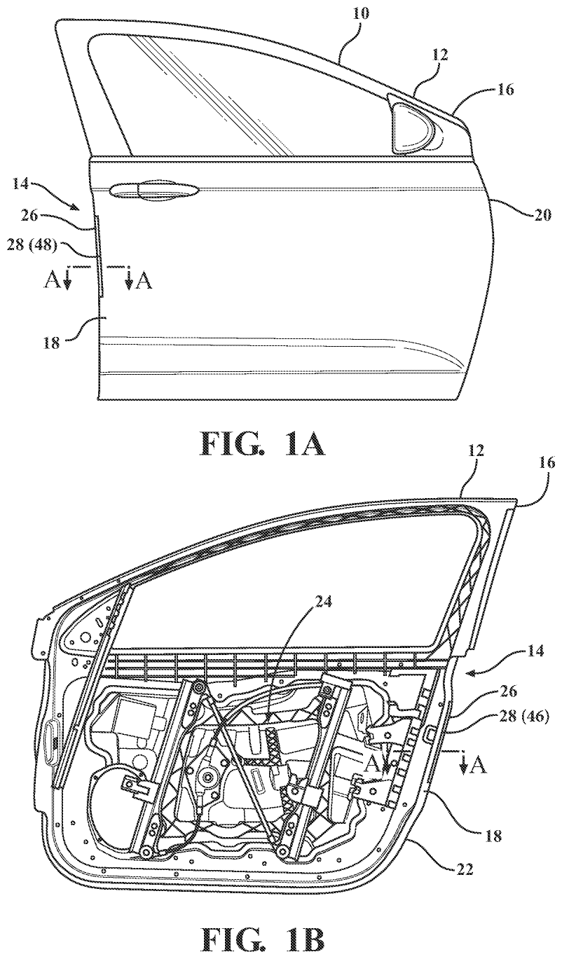

With reference to FIGS. 1A and 1B, the vehicle includes a body 12 that defines the exterior 10, including one or more door openings 14 that open between the compartments and the exterior 10. Relatedly, the body 12 includes one or more doors 16 corresponding to the door openings 14. The doors 16 serve as closure panels for the compartments. The doors 16 are pivotally, slidingly, or otherwise connected to the remainder of the body 12 for movement, relative to the corresponding door openings 14, between closed positions and open positions.

For brevity, this description follows with reference to a single door 16 of the vehicle. By extension, this description follows with reference to the other door(s) 16 of the vehicle. The door 16 can be any type of vehicle door, for example, a front side door, a rear side door, a hatch, a tailgate, a trunk, or a hood. The door 16 can be a manually-operated vehicle door, and/or the door can be a powered vehicle door. The door 16 is configured to open away from the corresponding door opening 14 on a hinge about an axis. The axis can be substantially vertically aligned, or the axis can be substantially horizontally aligned. For example, the door 16 can be a side door of the vehicle that opens about a substantially vertical axis. In another example, the door 16 can be a trunk of the vehicle that opens about a substantially horizontal axis.

The door 16 includes a peripheral flange 18. In the closed position, the door 16 is positioned over the corresponding door opening 14. With the corresponding door opening 14 framed by the surrounding body 12, the door 16 overlaps the surrounding body 12 at the peripheral flange 18. In the open position, the door 16 is positioned away from the corresponding door opening 14, which allows ingress into, egress out of, and like access to the compartments of the vehicle.

The door 16 includes an outer door panel 20 and an inner door panel 22. The outer door panel 20 and the inner door panel 22 are hemmed together or otherwise rigidly interconnected to one another along the peripheral flange 18. Otherwise, the outer door panel 20 and the inner door panel 22 are spaced apart from one another. As a result, the door 16 has an interior door cavity 24 defined between the outer door panel 20 and the inner door panel 22.

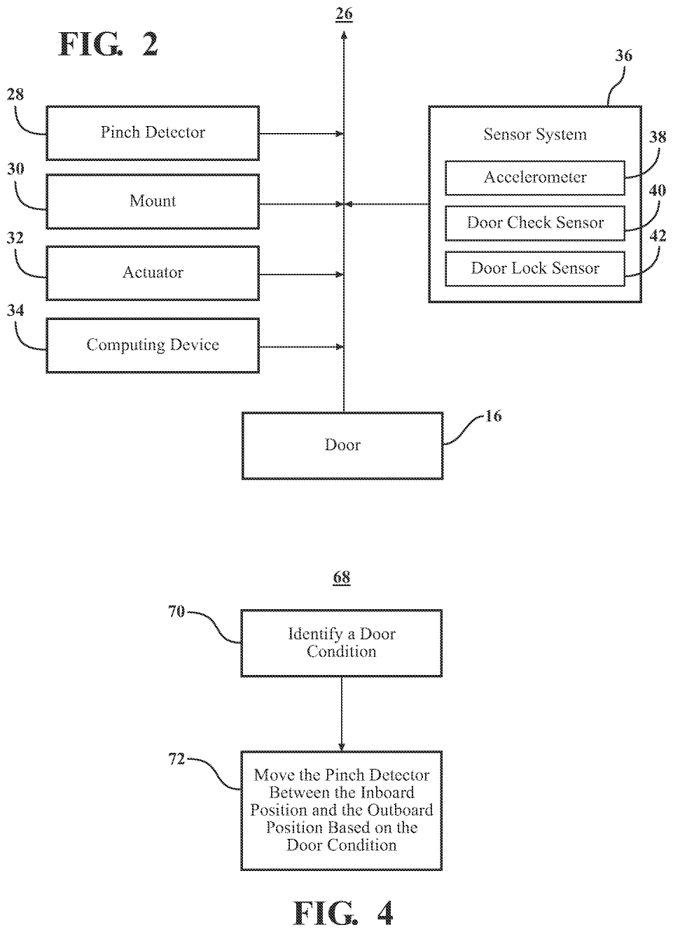

With reference to FIG. 2, the door 16 can include a pinch detection system 26. The pinch detection system 26 can include a pinch detector 28, a mount 30, an actuator 32, a computing device 34, and a sensor system 36, including an accelerometer 38, a door check sensor 40, and a door lock sensor 42. Each of these elements will now be described in turn below.

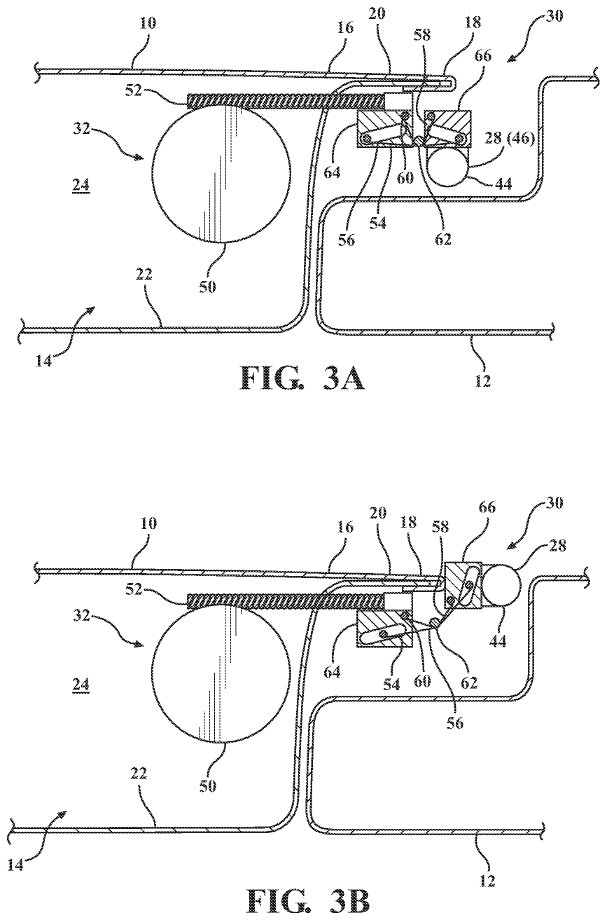

With reference to FIGS. 3A-3C, the pinch detector 28 can be connected to the door 16 along the peripheral flange 18. The pinch detector 28 can have an elongated body 44 that extends lengthwise along the peripheral flange 18. In general, the pinch detector 28 is configured to detect contact with objects adjacent the pinch detector 28. For instance, the pinch detector 28 can be configured to detect evident (i.e., actual) contact with objects adjacent the pinch detector 28. In another instance, the pinch detector 28 can be configured to detect prospective (i.e., potential or impending) contact with objects adjacent the pinch detector 28.

The pinch detector 28 is supported by the door 16 for movement, relative to the door 16, around the peripheral flange 18, between an inboard position 46 and an outboard position 48. In the inboard position 46, the pinch detector 28 is located along the inside of the peripheral flange 18. In the outboard position 48, the pinch detector 28 is located along the outside of the peripheral flange 18. From the inboard position 46, the pinch detector 28 is configured to detect contact between the inside of the peripheral flange 18 and objects such as a person's finger, hand, arm, and/or leg, against the surrounding body 12 when the door 16 is being closed. From the outboard position 48, the pinch detector 28 is also configured to detect contact between the outside of the peripheral flange 18 and objects such as a wall, an adjacent vehicle, or a person standing next to the door 16, when the door 16 is being opened.

As mentioned above, the pinch detector 28 is supported by the door 16 for movement, relative to the door 16, between the inboard position 46 and the outboard position 48. Accordingly, as mentioned above, the door 16 includes a mount 30 mountable to the door 16 and configured to support the pinch detector 28 for movement between the inboard position 46 and the outboard position 48. The mount 30 is connected to the door 16 and is configured to support the elongated body 44 of the pinch detector 28 to extend lengthwise along the peripheral flange 18 in and for movement between the inboard position 46 and the outboard position 48.

The mount 30 can be any suitable mount. In one implementation, as shown in FIGS. 3A-3C, the mount 30 can include a six-bar concealed hinge. In this example, the mount 30 includes a linkage 54. The linkage 54 is connected to the pinch detector 28 and is configured to support the pinch detector 28 for movement between the inboard position 46 and the outboard position 48. The linkage 54 includes a driving link 56, an auxiliary link 58, a drive pin 60, a connecting pin 62, a mounting block 64, and a support block 66. The mounting block 64 is configured to mount the linkage 54 to the door 16 and the support block 66 is configured to support the pinch detector 28. The drive pin 60 is connected to the mounting block 64, is rotatable within the mounting block 64, and is fixed with respect to the peripheral flange 18. The driving link 56 is connected to the mounting block 64 by a pin and slot and is fixedly connected to the support block 66. The auxiliary link 58 is connected to the support block 66 by a pin and slot and is fixedly connected to the mounting block 64. Together, the driving link 56 and the auxiliary link 58 are connected at a common axis by the connecting pin 62.

In order to activate the mount 30 to move the pinch detector 28 between the inboard position 46 and the outboard position 48, the pinch detection system 26 includes an actuator 32, as mentioned above. The actuator 32 can be any suitable actuator 32. In one implementation, as shown in FIGS. 3A-3C, the actuator 32 includes a motor 50 and a worm gear 52. The motor 50 is connected to the door 16 and the worm gear 52 and is located inside the interior door cavity 24. The motor 50 is configured to drive the worm gear 52. The worm gear 52 is connected to the motor 50 and the linkage 54 and is configured to move the linkage 54 when rotated. In operation, the motor 50 rotates to drive the worm gear 52, which rotates the drive pin 60. As the drive pin 60 rotates, the linkage 54 rotates about the drive pin 60 and around the peripheral flange 18 to move the pinch detector 28 from the inboard position 46 to the outboard position 48.

In order to determine when the actuator 32 should be operated to move the pinch detector 28, the vehicle can include a computing device 34 and a sensor system 36, as mentioned above. Referring back to FIG. 2, the computing device 34 can be operatively connected to the actuator 32 and the sensor system 36. The computing device 34 can be dedicated to operating one or more components of the pinch detection system 26, or could additionally support the operation of other systems of the vehicle. The computing device 34 may include one or more processors communicatively coupled with a memory. The processor(s) may include any device capable of executing machine-readable instructions, which may be stored on a non-transitory computer-readable medium, for example, the memory. The processor(s) may include a controller, an integrated circuit, a microchip, a computer, and/or any other computing device.

The memory may include any type of computer-readable medium suitable for storing data and algorithms. For example, the memory may include RAM, ROM, a flash memory, a hard drive, and/or any device capable of storing machine-readable instructions. Various algorithms and data for operating the components of the pinch detection system 26 may reside in whole or in part in the memory. The computing device 34 may, for instance, have a module residing in memory for operating the components of the pinch detection system 26.

The sensor system 36 can be configured to determine data and/or information about the door 16. The sensor system 36 can include an accelerometer 38, as mentioned above. The accelerometer 38 can measure the acceleration of the door 16 and the direction of acceleration of the door 16 when it is being opened or closed. The sensor system 36 can also include a door check sensor 40. The door check sensor 40 can determine the position of the door 16 with respect to the body 12. The door check sensor 40 can measure rotation of the door 16 about the door check and/or the door hinge. The door check sensor 40 can be any suitable sensor. For example, the door check sensor 40 can be a rotary sensor. The sensor system 36 can also include a door lock sensor 42. The door lock sensor 42 can determine if the door 16 is locked or unlocked.

The computing device 34 can receive and/or collect data and/or information from the sensor system 36 and identify a door condition based on the data and/or information. The door condition can be an opening condition, in which the door 16 is being opened (i.e., moved toward the open position), or a closing condition, in which the door 16 is being closed (i.e., moved toward the closed position). The computing device 34 can determine the door condition using the data and/or information from the sensor system 36. For example, if the door check sensor 40 determines that the door 16 is in the open position, and the accelerometer 38 determines that the door 16 is accelerating towards the closed position, and the door lock sensor 42 determines that the door 16 is unlocked, the computing device 34 can identify the closing condition. Similarly, if the door check sensor 40 determines that the door 16 is in the closed position, and the accelerometer 38 determines that the door 16 is accelerating towards the open position, and the door lock sensor 42 determines that the door 16 is unlocked, the computing device 34 can identify the opening condition. When the computing device 34 identifies the opening condition, the computing device 34 can be configured to operate the actuator 32 to activate the mount 30 to move the pinch detector 28 from the inboard position 46 to the outboard position 48, or otherwise cause the pinch detector 28 to remain in the outboard position 48. When the computing device 34 identifies the closing condition, the computing device 34 can operate the actuator 32 to activate the mount 30 to move the pinch detector 28 from the outboard position 48 to the inboard position 46, or otherwise cause the pinch detector 28 to remain in the inboard position 46.

Now that the various potential systems, devices, elements, and/or components have been described, a method, including various possible steps of such method, will now be described. The method described may be applicable to the arrangements described above, but it is to be understood that the method can be carried out with other suitable systems and arrangements. Moreover, the method may include other steps not shown here, and the method is not limited to including every step shown. The blocks illustrated here as part of the method are not limited to the particular chronological order. Indeed, some of the blocks may be performed in a different order than what is shown and/or at least some of the blocks shown can occur simultaneously.

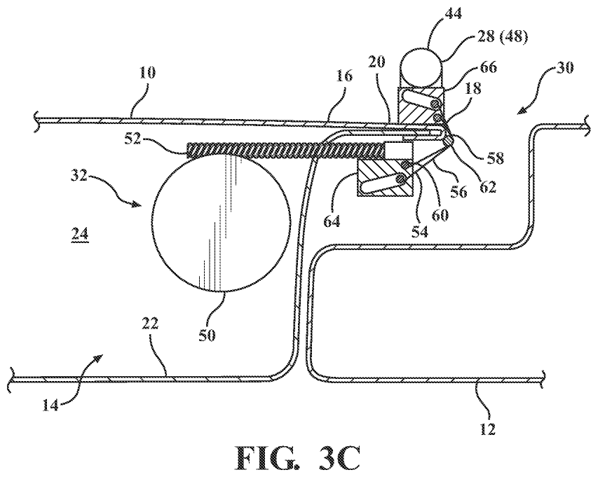

Referring to FIG. 4, an example of a method 68 is shown. In operation 70, a door condition can be identified. As described herein, the door condition can be an opening condition or a closing condition. The door condition can be identified by the computing device 34 based on data and/or information received from the sensor system 36. The method 68 can continue to operation 72. In operation 72, responsive to the identified door condition, the actuator 32 can be caused to be operated to activate the mount 30 to move the pinch detector 28 between the inboard position 46 and the outboard position 48. The computing device 34 can operate the actuator 32 to activate the mount 30 to move the pinch detector 28. For example, when the opening condition is identified, the actuator 32 can be operated to activate the mount 30 to move the pinch detector 28 from the inboard position 46 to the outboard position 48 or otherwise keep the pinch detector 28 in the outboard position 48. Similarly, when the closing condition is identified, the actuator 32 can be operated to activate the mount 30 to move the pinch detector 28 from the outboard position 48 to the inboard position 46 or otherwise keep the pinch detector 28 in the inboard position 46.

While recited characteristics and conditions of the invention have been described in connection with certain embodiments, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A door pinch detection system, comprising:
a pinch detector, the pinch detector configured to detect contact with objects adjacent the pinch detector;
a mount for the pinch detector, the mount mountable to a vehicle door including a peripheral flange, and configured to support the pinch detector for movement between an inboard position and an outboard position, in which the pinch detector is respectively located along the inside and the outside of the peripheral flange and configured to detect contact between the inside and the outside of the peripheral flange and objects; and
an actuator for the mount, the actuator mountable to the vehicle door and connectable between the vehicle door and the mount, and operable to activate the mount to move the pinch detector between the inboard position and the outboard position.

2. The door pinch detection system of claim 1, wherein the pinch detector includes an elongated body, and wherein the mount is configured to support the elongated body to extend lengthwise along the peripheral flange in the inboard position and the outboard position.

3. The door pinch detection system of claim 1, wherein the actuator comprises a motor connected to a worm gear, wherein the mount comprises a linkage, and wherein operation of the motor rotates the worm gear to drive the linkage to move the pinch detector between the inboard position and the outboard position.

4. The door pinch detection system of claim 1, further comprising:
a computing device operatively connected to the actuator, the computing device configured to identify a door condition, and, responsive to identifying the door condition, operate the actuator to activate the mount to move the pinch detector between the inboard position and the outboard position.

5. The door pinch detection system of claim 4, wherein identifying a door condition includes identifying an opening condition, and wherein operating the actuator to activate the mount to move the pinch detector between the inboard position and the outboard position includes at least one of when the pinch detector is in the inboard position, operating the actuator to activate the mount to move the pinch detector from the inboard position to the outboard position, and when the pinch detector is in the outboard position, operating the actuator to activate the mount to keep the pinch detector in the outboard position.

6. The door pinch detection system of claim 4, wherein identifying a door condition includes identifying a closing condition, and wherein operating the actuator to activate the mount to move the pinch detector between the inboard position and the outboard position includes at least one of when the pinch detector is in the outboard position, operating the actuator to activate the mount to move the pinch detector from the outboard position to the inboard position, and when the pinch detector is in the inboard position, operating the actuator to activate the mount to keep the pinch detector in the inboard position.

7. The door pinch detection system of claim 4, further comprising:
a sensor system configured to determine information about the vehicle door, the sensor system including at least one of an accelerometer, a door check sensor, and a door lock sensor.

8. The door pinch detection system of claim 7, wherein the computing device is configured to determine the door condition based on the information about the vehicle door determined by the sensor system.

9. The door pinch detection system of claim 1, wherein the vehicle door is a powered vehicle door.

10. The door pinch detection system of claim 1, wherein the vehicle door is one of a vehicle side door, hatch, tailgate, trunk, and hood.
